(19) United States
(12) Patent Application Publication
(10) Pub. No.: US 2024/0196221 A1
(43) Pub. Date: Jun. 13, 2024

(54) Cellular Site Image Capture and Storage

(71) Applicant: T-Mobile USA, Inc., Bellevue, WA (US)

(72) Inventor: Joseph Lee, Atlanta, GA (US)

(21) Appl. No.: 18/064,792

(22) Filed: Dec. 12, 2022

(51) Int. Cl. H04W 12/63; H04M 1/72457; H04M 1/72463; H04W 12/06

(52) U.S. Cl. CPC H04W 12/63; H04M 1/72457; H04M 1/724631; H04W 12/06

(57) ABSTRACT

Described herein is a user equipment (UE) configured with a cellular site image capture application. The cellular site image capture application receives user input associated with a specific cellular site. The UE uses the user input to authenticate the cellular site, and, based at least in part on the authenticating, the cellular site image capture application enables an image capture feature of the application. An image of the specific cellular site is then captured through the cellular site image capture application. The cellular site image capture application then disables the image capture feature following the image capturing. In some examples, the cellular site image capture application sends the image to an image storage system. The image storage system receives images of cellular sites from a plurality of UEs, stores those images, and provides them to a UE in response to a request.

### BACKGROUND

Cellular Site technicians often must visit remote locations and locations with obstacles and hazards in order to service cellular site equipment. Documenting the status of that equipment and its surroundings is often made easier by capturing images (e.g., photographs and videos). Such images may be difficult to move among devices of a cellular site technician, however, and may also be difficult to share between technicians. And while image sharing systems exist that could be used for exchanging cellular site images, the image sharing systems typically are designed for personal use and include images unrelated to the work of cellular site maintenance.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows example user interfaces of a cellular site image capture application with an image capture feature that is enabled based on user input and disabled following image capture.

FIG. 2 shows an example of a network environment with a UE in the vicinity of a cellular site, the UE connected via a base station of the cellular site or different access point to an image storage system capable of storing cellular site images captured by the UE.

FIG. 3 shows an example of a system architecture for a UE.

FIG. 4 shows an example of a system architecture for an image storage system.

FIG. 5 shows a flowchart of an example method by which a UE is configured with a cellular site image capture application for capturing cellular site images, when enabled, and sending those images to an image storage system.

FIG. 6 shows a flowchart of an example method by which an image storage system is configured to store images of cellular sites captured by cellular site technicians using their UEs.

### DETAILED DESCRIPTION

Described herein are devices and methods that enable cellular site technicians and others wishing to depict or document cellular sites to capture images of cellular sites and store those images in a shared storage system while limiting the images that can be captured and stored by enabling and disabling an image capture feature. A user in the vicinity of a cellular site may activate a cellular site image capture application and provide validation information (e.g., a cellular site identifier). That validation information may then be used to enable the image capture feature cellular site image capture application, allowing the user to capture an image of the cellular site. The image is then provided to the image storage system and the image capture feature is disabled (e.g., timed out, minimized, etc.). By requiring authentication to enable image capture and disabling after image capture, the image storage system receives images of the cellular site and avoids inclusion of, e.g., personal images of the user. The image storage system, receiving the images of multiple users, makes those images available among the users and selectively deletes ones of the stored images based on criteria to help ensure that the stored images are relevant.

As used herein, an “image” may be a photograph, a video, a video clip, or any sort of visual media or visual multimedia. It may also refer to multiple ones of these: an image received from one UE may be a photograph and an image received from another UE may be a video. A given UE providing multiple images may even be providing both a photograph and a video.

In various implementations, in addition to image capture, the cellular site image capture application may enable a user to provide supplementary information, such as textual annotations, voice notes, drawn/selected visual annotations (e.g., a user-drawn arrow pointing to a feature of interest in an image). The cellular site image capture application may also allow viewing of images and supplementary information previously sent by the user or images and supplementary information previously sent to the image storage system by other users.

### Example User Interfaces

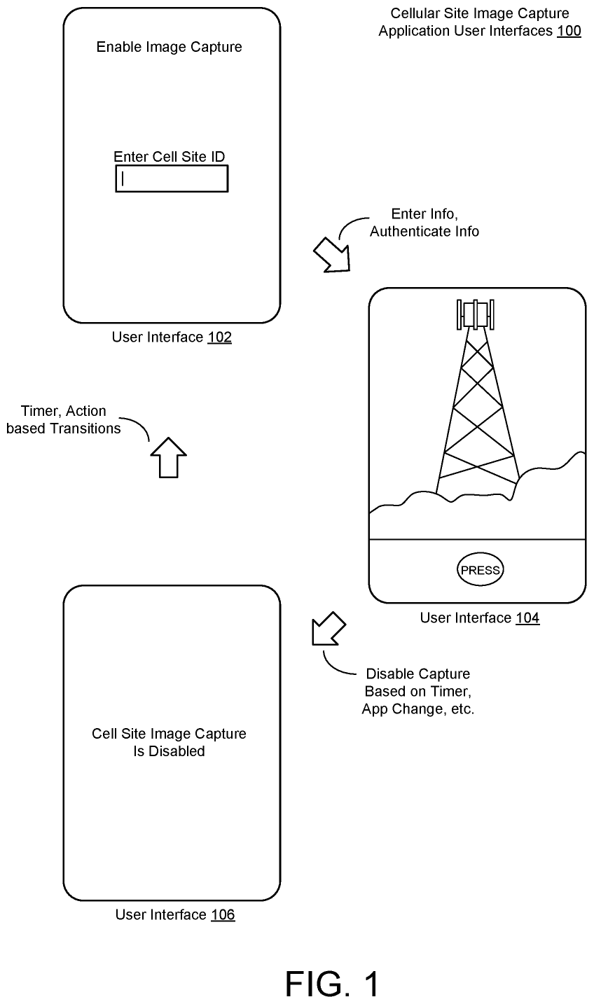

FIG. 1 shows example user interfaces 100 of a cellular site image capture application with an image capture feature that is enabled based on user input and disabled following image capture. User interface 102 shows an initial screen for a user to provide input for authentication of a cellular site based on the input, prior to enabling of an image capture feature. User interface 104 shows a screen with an image capture button and a field of view of a cellular site to be depicted in an image capture. User interface 106 shows a screen informing the user that the image capture feature has been disabled.

In various implementations, a user (e.g., a cellular site technician) selecting a cellular site image capture application (e.g., clicking on an icon for the cellular site image capture application or entering a uniform resource locator (URL) for the cellular site image capture application in a browser window) may first be presented with user interface 102, which requests that the user input information, such as a cellular site identifier, a cellular site location, etc. The user can enter the information and, if needed, take some further action (e.g., click the entry box or screen) to submit the information. At a base station, an access point, a core network of a telecommunication network, an image storage system, or other remote service or system, the information entered by the user can be authenticated. This may involve comparing the information entered by the user, a location of the user, and known cellular site identifiers and locations to determine if there is a match. If there is, the user may be presented with user interface 104.

As shown in user interface 104, the UE of the user may present an image capture screen showing the field of view that is to be captured in an image as well as an image capture control (shown in user interface 104 as a user interface button with the label “PRESS”). As the user moves the UE, the field of view changes, as does the content of the image produced by an image capture. In addition to enabling a user to capture one or more images, the user interface 104 may also enable entry of supplementary information. Though not shown in FIG. 1, the user interface 104 may be updated to present a screen with one or more entry or editing controls that, e.g., enable a user to enter graphics and text on a capture image, enter text generally applicable to a captured image, enter voice text, crop a capture image, etc. Either automatically after each input or capture, or at a preset time after the last input or capture, image(s) and any supplementary information are provided from the UE to an image storage system.

Next, the user may be presented with a user interface 106 informing the user that the image capture feature of the cellular site image capture application is disabled. The image capture feature may be disabled responsive to activation of a UE lock screen, change in a UE location, passage of a predetermined time period, or activation of another UE application, service, or feature. Once user interface 106 has been displayed (or responsive to minimization of the cellular site image capture application or user interaction with the user interface 106), the cellular site image capture application may transition back to user interface 102. In some implementations, there may be no user interface 106, and the cellular site image capture application may transition directly back from user interface 104 to user interface 102.

In various implementations, the user interfaces 100 may also include a further user interface, not shown, for the user to request remotely stored images from the image storage system, receive and display those images, and to provide additional edits, changes, etc. Such a user interface may also require a use to input a cellular site identifier or location in order to see previously captured image(s) for that identifier or location.

### Example Network Environment

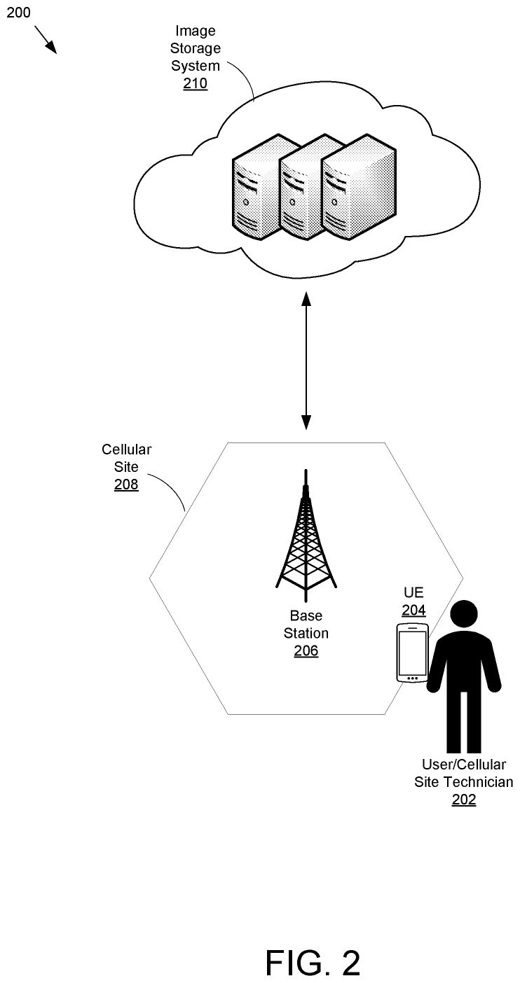

FIG. 2 shows an example of a network environment with a UE in the vicinity of a cellular site, the UE connected via a base station of the cellular site or different access point to an image storage system capable of storing cellular site images captured by the UE. As illustrated, a user (e.g., cellular site technician) 202 may be present with a UE 204 in the vicinity of a base station 206 an its surrounding cellular site 208. The user 202 may capture an image of the cellular site 208 (e.g., of the base station 206) using the UE 204 and provide the image to a remote image storage system 210 (e.g., via a telecommunication network connecting the UE 204).

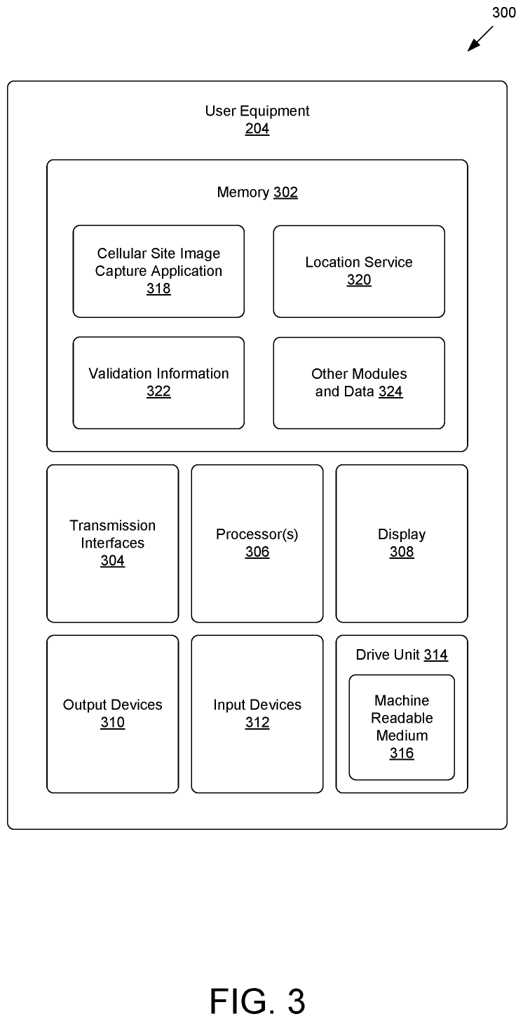

In various implementations, the UE 204 may be any sort of user device that is capable of wireless communication, equipped with a camera, and configured with a cellular site image capture application. Examples of UE 204 may include cellular devices, mobile devices, Internet-of-Things (IOT) devices, augmented reality/virtual reality (AR/VR) devices, wearable devices, laptops, desktops, media players, gaming devices, or any other sort of computing device of any form factor. The UE 204 may support any sort of radio access type, such as fifth generation (5G)/new radio (NR), fourth generation (4G)/Long Term Evolution (LTE) and may also support Wi-Fi communication. An example system architecture of a UE 204 is shown in FIG. 3 and described below in detail with reference to that figure.

The base station 206 of cellular site 208 may be any sort of radio access point associated with a radio access network. The base station 206 may be one of one or more base stations of the cellular site 208. The cellular site 208 has a geographic area and may have other network equipment. The base station 206 may be associated with a specific radio access type, such as 5G/NR, 4G/LTE, or a newer or older generation radio access type.

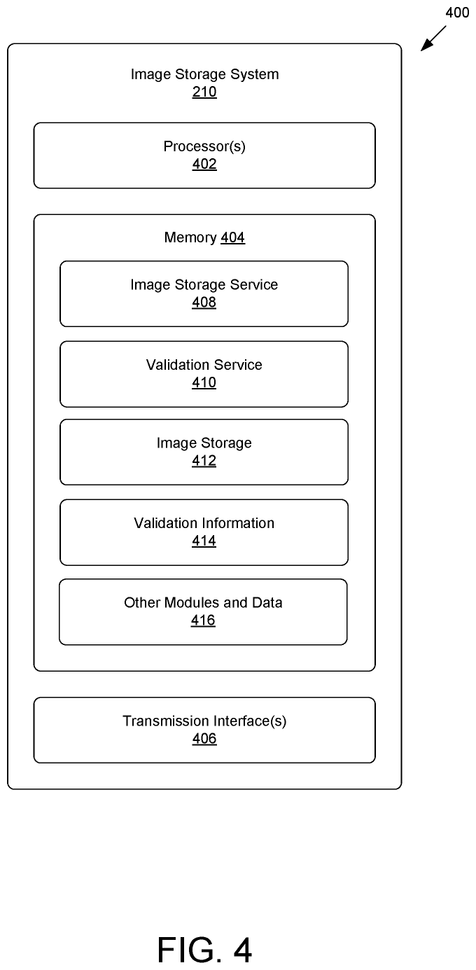

In some implementations, the image storage system 210 may comprise a storage cloud service with multiple devices storing images from multiple UEs 204 of multiple users 202. Such devices may be any of servers, mainframes, hard drives, or other computing devices and may form part of, e.g., a server farm or other mass storage environment. An example system architecture of an image storage system 210 is shown in FIG. 4 and described below in detail with reference to that figure.

In some examples, the image storage system 210 may comprise part of the telecommunication network that includes the base station 206, such as part of a core network, part of an Internet Protocol (IP) multimedia subsystem (IMS), or part of another network associated with the telecommunication network. Additionally, the telecommunication network may provide connectivity between the UE 204 and the image storage system 210, through its core network and through the base station 206, another base station of the cellular site 208, or another access point in the vicinity of the cellular site 208, such as a Wi-Fi access point.

In various implementations, users 202 may travel to cellular sites 208 in a variety of locations. Some cellular sites 208 may be in rural settings and difficult to access, may be surrounded by neighbors who are unhappy about their nearby base station 206 and its maintenance, or may have wild animals or harmful plants that threaten visitors. Thus, accurately depicting and documenting cellular sites 208 and sharing that information with other cellular site technicians and users 202 is important in both providing up-to-date information and minimizing unnecessary travel to the cellular sites 208.

Upon arriving at the cellular site 208, the UE 204 of the user 202 automatically connects to a telecommunication network through the base station 206, through another base station of the cellular site 208, or through another wireless access point in the vicinity. The user 202 may then open the cellular site image capture application on the UE 204, which may connect to a remote service, such as a remote service of the image storage system 210. The user 202 may be presented with a user interface such as user interface 102, requesting input from the user 202 prior to enabling an image capture feature, or with a user interface allowing the user 202 to request and receive images of the cellular site 208. Upon being provided with such images from the image storage system 210, the user 202, comparing such images to the cellular site 208 in front of the user 202, may use the cellular site image capture application to make annotations or edits using voice, text, or graphic/touch input, which may then be saved with the served image.

In some implementations, when the user 202 is presented with a user interface 102, the user 202 may input information such as a cellular site identifier or cellular site location. In some examples, the user may enter the cellular site identifier and the cellular site image capture application may utilize a location component of the UE 204 to determine a current location of the UE 204. The cellular site image capture application may then send the cellular site identifier and UE 204 location to a remote location for authentication or may perform authentication locally. Such a remote location may be the base station 206, other network equipment of the cellular site 208, a service of the core network, an IMS service, a service of the image storage system 210, or another remote service accessed through the telecommunication network. The remote location and its service may have access to information listing cellular site identifiers and corresponding locations, and the service, upon receiving the cellular site identifier and UE 204 location from the cellular site image capture application, may determine if there is a match. For local authentication, the UE 204 may be provisioned with a list of cellular site identifiers and associated locations and determine if there is a match. If there is, the remote service/local UE may respond to the cellular site image capture application with a positive indication, which the cellular site image capture application may in turn take as signal to enable an image capture feature of the cellular site image capture application.

Such an image capture feature and its user interface 104 are described in greater detail with regard to FIG. 1. The user 202 may position the UE 204 and its camera to obtain a desired field of view and then press a control of the user interface 104 (e.g., a user interface button) to cause the cellular site image capture application to capture an image. The image may be provided to the image storage system 210 upon capture, after a time period, or upon an indication from the user 202 that the image should be uploaded. The user 202 may also provide supplementary information, such as edits or annotations to the image made through text, voice, or touch/graphic input. This supplementary information may also be provided to the image storage system 210 upon entry, or after a time period, or upon an indication from the user 202 that the supplementary information should be uploaded. The user 202 may then capture additional images or provide additional supplementary information.

When the user 202 is finished with image capture, the user 202 may do other things (e.g., maintenance at the cellular site 208) and depart.

Following at some point after image capture, the cellular site image capture application disables the image capture feature. The image capture feature may be disabled responsive to activation of a UE 204 lock screen, change in a UE 204 location, passage of a predetermined time period, or activation of another UE 204 application, service, or feature. This may cause a user interface 106 to be displayed to the user 202 the next time the cellular site image capture application is viewed, informing the user 202 that the image capture feature is disabled.

In some implementations, the cellular site image capture application may also retrieve images and associated supplementary information from the image storage system 210. The user 202 may be at any location when the cellular site image capture application retrieves the images from the image storage system 210 and its image capture feature may be enabled or disabled. As described elsewhere herein, the user 202 may be presented with images and supplementary information, and the user 202 may edit or annotate the images and supplementary information. Any changes or additions are then, in turn, provided by the cellular site image capture application to the image storage system 210.

In various implementations, the image storage system 210 receives images and supplementary information from multiple UEs 204 at multiple cellular sites 208 and store the images and supplementary information. Such storage can comprise storage across multiple devices or in a single device. In some examples, when storing images, the image storage system 210 can annotate one of the images with an identifier of a user 202 that captured the image, with a location where the image was captured, or with a time when the image was captured (or, rather than annotating, the image storage system 210 may store that information as image metadata).

The storage can also involve pruning the totality of images stored—deleting images based, e.g., on time since upload, time since an image has been viewed, time since supplementary information for an image has been viewed or edited, etc. Other considerations for deleting or retaining images in the image storage system 210 may include user input, a location (cellular site 208) of the at least one of the images, or receipt of a more recent image of a cellular site 208 depicted in the at least one of the images.

In some implementations, the image storage system 210 may receive requests for stored images from users 202 through their UEs 204 and may provide the requested images and any associated supplementary information to the requesting users 202. In return, the image storage system 210 may receive additional edits or annotations, as described further herein, and update the stored images and supplementary information with the edits or annotations.

Further, in some examples, the image storage system 210 may participate in authenticating the cellular site 208 based on the user input to enable image capture features. The details of this are described further herein.

### Example Architectures

FIG. 3 shows an example of a system architecture 300 for a UE, such as UE 204. As shown, the UE 204 can have at least one memory 302, one or more transmission interfaces 304, processor(s) 306, a display 308, output devices 310, input devices 312, and/or a drive unit 314 including a machine readable medium 316.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the UE 204. Any such non-transitory computer-readable media may be part of the UE 204.

The memory 302 can include one or more software or firmware elements, such as computer-readable instructions that are executable by the one or more processors 306. For example, the memory 302 can store computer-executable instructions associated with the cellular site image capture application 318 and a location service 320 (e.g., a global positioning system (GPS) component). The memory 302 can also store data such as validation information 322 (e.g., the above-described information used for local authentication). These components and data 318-322 are all described further herein in detail. The memory 302 can also store other modules and data 324, which can be utilized by the UE 204 to perform or enable performing any action taken by the UE 204. The other modules and data 324 can include a UE platform, operating system, and applications, and data utilized by the platform, operating system, and applications.

The transmission interfaces 304 can include transceivers, modems, interfaces, antennas, and/or other components that perform or assist in exchanging RF communications with base stations, such as base station 206, a Wi-Fi access point, or otherwise implement connections with one or more networks. The transmission interfaces 304 can be compatible with one or more radio access technologies, such as 5G NR radio access technologies and/or LTE radio access technologies.

In various examples, the processor(s) 306 can be a CPU, a graphics processing unit (GPU), or both CPU and GPU, or any other type of processing unit. Each of the one or more processor(s) 306 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 306 may also be responsible for executing all computer applications stored in the memory 302, which can be associated with types of volatile (RAM) and/or nonvolatile (ROM) memory.

The display 308 can be a liquid crystal display or any other type of display commonly used in UEs. For example, the display 308 may be a touch-sensitive display screen and can thus also act as an input device or keypad, such as for providing a soft-key keyboard, navigation buttons, or any other type of input.

The output devices 310 can include any sort of output devices known in the art, such as the display 308, speakers, a vibrating mechanism, and/or a tactile feedback mechanism. Output devices 310 can also include ports for one or more peripheral devices, such as headphones, peripheral speakers, and/or a peripheral display.

The input devices 312 can include any sort of input devices known in the art. For example, input devices 312 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism. Further, input devices 312 include at least a camera for capturing images. Such a camera may include any sort or image capturing component.

The machine readable medium 316 can store one or more sets of instructions, such as software or firmware, that embodies any one or more of the methodologies or functions described herein. The instructions can also reside, completely or at least partially, within the memory 302, processor(s) 306, and/or transmission interface(s) 304 during execution thereof by the UE 204.

FIG. 4 shows an example of a system architecture 400 for an image storage system, such as system 210. As shown, the system 210 can include processor(s) 402, memory 404, and transmission interfaces 406.

The processor(s) 402 may be a CPU or any other type of processing unit. Each of the one or more processor(s) 402 may have numerous ALUs that perform arithmetic and logical operations, as well as one or more CUs that extract instructions and stored content from processor cache memory, and then executes these instructions by calling on the ALUs, as necessary, during program execution. The processor(s) 402 may also be responsible for executing all computer-executable instructions and/or computer applications stored in the memory 404.

In various examples, the memory 404 can include system memory, which may be volatile (such as RAM), non-volatile (such as ROM, flash memory, etc.) or some combination of the two. The memory 404 can also include additional data storage devices (removable and/or non-removable) such as, for example, magnetic disks, optical disks, or tape. Memory 404 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD, or other optical storage, magnetic cassettes, magnetic tape, magnetic disk storage or other magnetic storage devices, or any other non-transitory medium which can be used to store the desired information and which can be accessed by the system 210. Any such non-transitory computer-readable media may be part of the system 210.

The memory 404 can store computer-readable instructions and/or other data associated with operations of the system 210. For example, the memory 404 can store an image storage service 408 and a validation service 410 (e.g., the above-described service used for cellular site authentication). Memory 404 may also include image storage 412 and validation information 414 (e.g., the above-described information used for cellular site authentication). The modules and data 408-414 are described further herein in greater detail. The other modules and data 416 can be utilized by the system 210 to perform or enable performing any action taken by the system 210. The other modules and data 416 can include a platform, operating system, firmware, and/or applications, and data utilized by the platform, operating system, firmware, and/or applications.

The transmission interfaces 406 can include any wired or wireless equipment connecting to UEs, such as UE 204 through a telecommunication network. Such a telecommunication network may include elements of a core network or a base station 206. In some implementations, the system 210 may be part of the core network or the base station 206. The composition of the transmission interfaces 406 may vary based on which device or devices they are incorporated into and what other functions those devices have. For example, if located in a cloud storage service, transmission interfaces 406 may be mostly or entirely wired interfaces.

### Example Operations

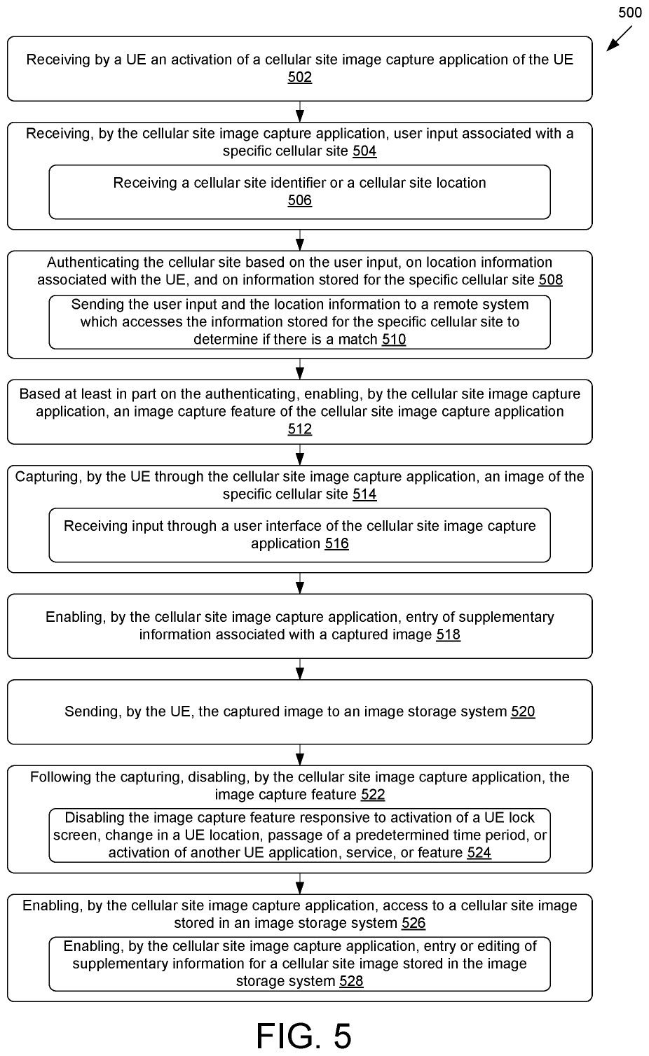

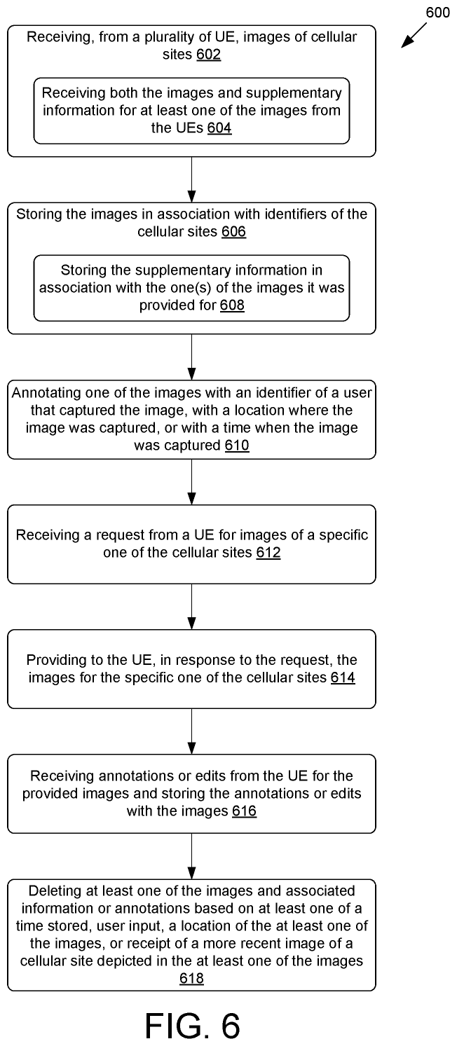

FIGS. 5 and 6 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 5 shows a flowchart of an example method by which a UE is configured with a cellular site image capture application for capturing cellular site images, when enabled, and sending those images to an image storage system. As illustrated in FIG. 5 at 502, the UE receives an activation of a cellular site image capture application of the UE.

At 504, the cellular site image capture application receives user input associated with a specific cellular site. At 506, receiving the user input may comprise receiving a cellular site identifier or a cellular site location.

At 508, based on the user input, on location information associated with the UE, and on information stored for the specific cellular site, the cellular site is authenticated. At 510, the authenticating may include sending the user input and the location information to a remote system which accesses the information stored for the specific cellular site to determine if there is a match.

At 512, based at least in part on the authenticating, the cellular site image capture application enables an image capture feature of the cellular site image capture application.

At 514, an image of the specific cellular site is captured by the UE through the cellular site image capture application. At 516, the capturing includes receiving input through a user interface of the cellular site image capture application. The cellular site image capture application presents the user interface while the image capture feature is enabled and ceases to present the user interface when the image capture feature is disabled.

At 518, the cellular site image capture application may also enable entry of supplementary information associated with a captured image.

At 520, the UE may send the captured image (and supplementary information, if entered) to an image storage system.

At 522, following the capturing of the image, the cellular site image capture application disables the image capture feature. At 524, the disabling comprises disabling the image capture feature responsive to activation of a UE lock screen, change in a UE location, passage of a predetermined time period, or activation of another UE application, service, or feature.

At 526, the cellular site image capture application may enable access to a cellular site image stored in an image storage system. At 528, the cellular site image capture application may further enable entry of supplementary information for a cellular site image stored in the image storage system or editing of supplementary information for a cellular site image stored in the image storage system.

FIG. 6 shows a flowchart of an example method by which an image storage system is configured to store images of cellular sites captured by cellular site technicians using their UEs. As illustrated in FIG. 6 at 602, a cellular site image storage system receives from a plurality of UE images of cellular sites. In some implementations, at 604, receiving the images of the cellular sites may include receiving the images and supplementary information for at least one of the images from the UEs.

At 606, the cellular site image storage system stores the images in association with identifiers of the cellular sites. In some implementations, at 608—e.g., when the cellular site image storage system received supplementary information—the cellular site image storage system stores both the images and the supplementary information in association with the one(s) of the images it was provided for.

At 610, the cellular site image storage system may annotate one of the images with an identifier of a user that captured the image, with a location where the image was captured, or with a time when the image was captured.

At 612, the cellular site image storage system receives a request from a UE for images of a specific one of the cellular sites.

At 614, the cellular site image storage system provides to the UE, in response to the request, the images for the specific one of the cellular sites.

At 616, the cellular site image storage system may receive annotations or edits from the UE for the provided images and store the annotations or edits with the images.

At 618, the cellular site image storage system may delete at least one of the images and associated information or annotations based on at least one of a time stored, user input, a location of the at least one of the images, or receipt of a more recent image of a cellular site depicted in the at least one of the images,

### CONCLUSION

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method comprising:
receiving, by a user equipment (UE), an activation of a cellular site image capture application of the UE;
receiving, by the cellular site image capture application, user input associated with a specific cellular site;
authenticating the specific cellular site based on the user input, on location information associated with the UE, and on information stored for the specific cellular site;
based at least in part on the authenticating, enabling, by the cellular site image capture application, an image capture feature of the cellular site image capture application;
capturing, by the UE through the cellular site image capture application, an image of the specific cellular site; and
following the capturing, disabling, by the cellular site image capture application, the image capture feature.

2. The method of claim 1, wherein receiving the user input comprises receiving a cellular site identifier or a cellular site location.

3. The method of claim 1, wherein the authenticating includes sending the user input and the location information to a remote system which accesses the information stored for the specific cellular site to determine if there is a match.

4. The method of claim 1, wherein the capturing includes receiving input through a user interface of the cellular site image capture application, the cellular site image capture application presenting the user interface while the image capture feature is enabled and ceasing to present the user interface when the image capture feature is disabled.

5. The method of claim 1, further comprising enabling, by the cellular site image capture application, entry of supplementary information associated with a captured image.

6. The method of claim 1, further comprising sending, by the UE, the captured image to an image storage system.

7. The method of claim 1, wherein the disabling comprises disabling the image capture feature responsive to activation of a UE lock screen, change in a UE location, passage of a predetermined time period, or activation of another UE application, service, or feature.

8. The method of claim 1, further comprising enabling, by the cellular site image capture application, access to a cellular site image stored in an image storage system.

9. The method of claim 8, further comprising enabling, by the cellular site image capture application, entry of supplementary information for a cellular site image stored in the image storage system or editing of supplementary information for a cellular site image stored in the image storage system.

10. A non-transitory computer storage medium having stored thereon a plurality of programming instructions that, when executed by a user equipment (UE), cause the UE to perform operations comprising:
receiving an activation of a cellular site image capture application of the UE;
receiving, by through the cellular site image capture application, user input associated with a specific cellular site;
authenticating the specific cellular site based on the user input, on location information associated with the UE, and on information stored for the specific cellular site;
based at least in part on the authenticating, enabling, through the cellular site image capture application, an image capture feature of the cellular site image capture application;
capturing, through the cellular site image capture application, an image of the specific cellular site; and
following the capturing, disabling, through the cellular site image capture application, the image capture feature.

11. The non-transitory computer storage medium of claim 10, wherein receiving the user input comprises receiving a cellular site identifier or a cellular site location.

12. The non-transitory computer storage medium of claim 10, wherein the capturing includes receiving input through a user interface of the cellular site image capture application, the cellular site image capture application presenting the user interface while the image capture feature is enabled and ceasing to present the user interface when the image capture feature is disabled.

13. The non-transitory computer storage medium of claim 10, wherein the operations further comprise enabling, through the cellular site image capture application, entry of supplementary information associated with a captured image.

14. The non-transitory computer storage medium of claim 10, wherein the operations further comprise sending the captured image to an image storage system.

15. The non-transitory computer storage medium of claim 10, wherein the disabling comprises disabling the image capture feature responsive to activation of a UE lock screen, change in a UE location, passage of a predetermined time period, or activation of another UE application, service, or feature.

16. A cellular site image storage system comprising:
a processor; and
a plurality of programming instructions that, when executed by the processor, cause the processor to perform operations including:
receiving, from a plurality of user equipment (UEs), images of cellular sites;
storing the images in association with identifiers of the cellular sites;
receiving a request from a UE for images of a specific one of the cellular sites; and
providing to the UE, in response to the request, the images for the specific one of the cellular sites.

17. The cellular site image storage system of claim 16, wherein receiving the images of the cellular sites comprises receiving both the images and supplementary information for one(s) of the images from the UEs and the storing comprises storing the supplementary information in association with the one(s) of the images it was provided for.

18. The cellular site image storage system of claim 16, wherein the operations further include annotating one of the images with an identifier of a user that captured the image, with a location where the image was captured, or with a time when the image was captured.

19. The cellular site image storage system of claim 16, wherein the operations further include receiving annotations or edits from the UE for the provided images and storing the annotations or edits with the images.

20. The cellular site image storage system of claim 16, wherein the operations further comprise deleting at least one of the images and associated information or annotations based on at least one of a time stored, user input, a location of the at least one of the images, or receipt of a more recent image of a cellular site depicted in the at least one of the images.
